(19) United States
(12) Patent Application Publication
(10) Pub. No.: US 2026/0127418 A1
(43) Pub. Date: May 7, 2026

(54) RECURSIVE GENERATIVE PLANNING SYSTEM WITH VERIFICATION MODULES AND USER FEEDBACK INTEGRATION

(71) Applicant: DEEP FOREST SCIENCES, INC., Palo Alto, CA (US)

(72) Inventors: SHREYAS VINAYA SATHYANARAYANA, Bangalore (IN); BHARATH SATHYANARAYANA, Berkeley, CA (US)

(73) Assignee: DEEP FOREST SCIENCES, INC., Palo Alto, CA (US)

(21) Appl. No.: 19/380,884

(22) Filed: Nov. 5, 2025

Related U.S. Application Data
(60) Provisional application No. 63/716,572, filed on Nov. 5, 2024.
(60) Provisional application No. 63/800,899, filed on May 6, 2025.

(51) Int. Cl. G06N 3/0475; G06N 3/044; G06N 3/045; G06N 3/092

(52) U.S. Cl. CPC G06N 3/0475; G06N 3/044; G06N 3/045; G06N 3/092

(57) ABSTRACT

Various aspects of the present disclosure relate to techniques for recursive generative planning system with verification modules and user feedback integration. An apparatus is configured to execute a recursive planning pipeline that integrates at least one generative model and at least one rule-based model to generate candidate transformation pathways for a target structure, apply one or more verification modules to evaluate validity, stability, and coherence of intermediate outputs, selectively regenerate portions of the candidate transformation pathways from a user-specified stage while preserving validated portions, and incorporate user feedback to refine subsequent pathway generation and model operation.

### CROSS REFERENCE TO RELATED APPLICATIONS

This application claims the benefit of U.S. Provisional Patent Application No. 63/716,572 entitled “TECHNIQUES FOR LLM-RETROSYNTHESIS” and filed on Nov. 5, 2024, for Shreyas Vinaya Sathyanarayana, et al., which is incorporated herein by reference. This application also claims the benefit of U.S. Provisional Patent Application No. 63/800,899 entitled “TECHNIQUES FOR LLM-RETROSYNTHESIS” and filed on May 6, 2025, for Shreyas Vinaya Sathyanarayana, et al., which is incorporated herein by reference.

### FIELD

The subject matter herein relates generally to computer-implemented systems for generative and recursive planning, and more particularly to apparatuses and methods that integrate large language models, rule-based or template-based reasoning engines, and multi-stage verification modules for generating and validating transformation pathways.

### BACKGROUND

Automated planning and pathway generation systems, including those used in chemical and materials synthesis, often rely on fixed rule-based algorithms that lack flexibility and fail to generalize to novel targets. While large language models (LLMs) offer generative capability, they are prone to producing invalid, unstable, or hallucinated outputs and typically lack mechanisms for user correction or adaptive refinement.

### SUMMARY

In one embodiment, an apparatus is configured to execute a recursive planning pipeline that integrates at least one generative model and at least one rule-based model to generate candidate transformation pathways for a target structure, apply one or more verification modules to evaluate validity, stability, and coherence of intermediate outputs, selectively regenerate portions of the candidate transformation pathways from a user-specified stage while preserving validated portions, and incorporate user feedback to refine subsequent pathway generation and model operation.

In one embodiment, a method is configured for executing a recursive planning pipeline that integrates at least one generative model and at least one rule-based model to generate candidate transformation pathways for a target structure, applying one or more verification modules to evaluate validity, stability, and coherence of intermediate outputs, selectively regenerating portions of the candidate transformation pathways from a user-specified stage while preserving validated portions, and incorporating user feedback to refine subsequent pathway generation and model operation.

In one embodiment, a computer program product is embodied on a non-transitory computer-readable medium comprising instructions that, when executed by a processor, cause the processor to perform operations comprising executing a recursive planning pipeline that integrates at least one generative model and at least one rule-based model to generate candidate transformation pathways for a target structure, applying one or more verification modules to evaluate validity, stability, and coherence of intermediate outputs, selectively regenerating portions of the candidate transformation pathways from a user-specified stage while preserving validated portions, and incorporating user feedback to refine subsequent pathway generation and model operation.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system in accordance with the subject matter disclosed herein;

FIG. 2 illustrates one example of an apparatus in accordance with the subject matter disclosed herein;

FIG. 3 illustrates a recursive generative planning workflow in accordance with the subject matter disclosed herein;

FIG. 4 illustrates a flowchart showing one example of a method in accordance with the subject matter disclosed herein; and

FIG. 5 illustrates a flowchart showing one example of a method in accordance with the subject matter disclosed herein.

### DETAILED DESCRIPTION

Conventional automated pathway generation systems, such as those used in retrosynthesis, reaction planning, or materials design, rely heavily on fixed rule-based algorithms or curated reaction templates. While such deterministic methods are reliable for well-characterized domains, they often fail to generalize beyond known reaction classes or molecular families. In contrast, recent advances in LLMs and other generative artificial intelligence (AI) techniques offer the ability to propose novel transformations and pathways by drawing on vast training data. However, these models frequently exhibit instability, generate chemically implausible structures, and lack mechanisms for validating or refining their outputs, leading to hallucinated, energetically infeasible, or synthetically inaccessible pathways.

These limitations are particularly acute in multi-domain applications. For example, purely organic synthesis models cannot easily adapt to inorganic or hybrid material systems such as semiconductor precursors or metal-organic frameworks (MOFs), where coordination geometry, lattice compatibility, and multi-element bonding require domain-specific validation. Likewise, inorganic planning systems are not designed to handle stereochemistry, protecting groups, or functional group compatibility that dominate organic and natural product synthesis. Existing architectures also fail to incorporate meaningful user feedback, making iterative improvement and expert-guided correction inefficient or impossible.

The subject matter herein addresses these challenges through a recursive generative planning architecture that integrates both generative and rule-based models within a unified framework. The system employs verification modules that evaluate validity, stability, and coherence of intermediate structures, together with metadata generation subsystems that annotate pathways with reaction, reagent, and literature information. The architecture further supports domain-specific validators and metadata protocols for both organic and inorganic systems, ensuring accurate representation of diverse molecular and material classes.

In operation, the system allows user interaction and feedback at any stage of pathway generation, enabling partial regeneration of sub-pathways while preserving validated segments. The system may operate across a distributed computing environment, with multiple worker nodes executing concurrent recursive analyses under control of a head node. A reinforcement learning component progressively adapts generation strategies based on accumulated user corrections and validation outcomes, yielding a self-improving platform capable of generating chemically valid and practically relevant pathways across multiple scientific domains.

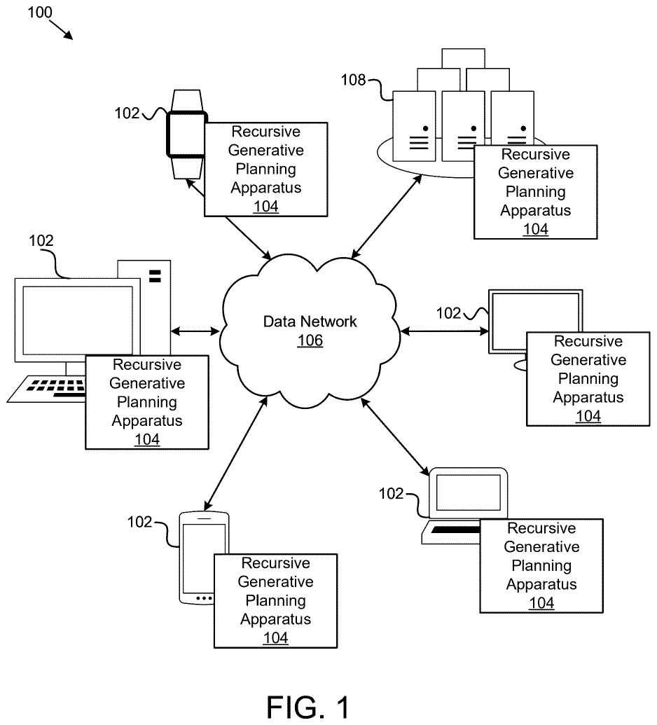

FIG. 1 is a schematic block diagram illustrating one embodiment of a system 100 for techniques for generative discriminative pipeline for low-k dielectrics. In one embodiment, the system 100 includes one or more information handling devices 102, one or more recursive generative planning apparatuses 104, one or more data networks 106, and one or more servers 108. In certain embodiments, even though a specific number of information handling devices 102, recursive generative planning apparatuses 104, data networks 106, and servers 108 are depicted in FIG. 1, one of skill in the art will recognize, in light of this disclosure, that any number of information handling devices 102, recursive generative planning apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In one embodiment, the recursive generative planning apparatus 104 is configured to execute a recursive planning pipeline that integrates a generative model and a rule-based model to generate candidate transformation pathways for a target structure. The recursive generative planning apparatus 104 applies verification modules to assess the validity, stability, and coherence of intermediate outputs produced during pathway generation, selectively regenerates portions of the pathways from user-specified stages while preserving validated segments, and incorporates user feedback to refine subsequent model operations. In certain implementations, the recursive generative planning apparatus 104 may further employ modules, domain-specific validators, and metadata generation subsystems for organic and inorganic molecular systems, enabling adaptive, verifiable discovery of thin-film precursor chemistries and other transformation processes within the generative-discriminative framework. Each module described below may be implemented as hardware, software, firmware, or a combination thereof, and collectively they enable automated discovery and optimization of thin-film materials for electronic, optical, and energy applications.

In certain embodiments, the recursive generative planning apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the recursive generative planning apparatus 104 may include a power interface, a wired and/or wireless network interface, a graphical interface that attaches to a display, and/or a semiconductor integrated circuit device as described below, configured to perform the functions described herein with regard to the recursive generative planning apparatus 104.

The recursive generative planning apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the recursive generative planning apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the recursive generative planning apparatus 104.

The semiconductor integrated circuit device or other hardware appliance of the recursive generative planning apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the recursive generative planning apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to execute or run machine learning algorithms, programs, applications, processes, and/or the like; communicate with a thermal imaging device; store thermal imaging data in a database, blockchain, or other secure data structure; and/or the like.

In operation, the recursive generative planning apparatus 104 may communicate with one or more servers 108 through the data network 106 to access distributed computational resources, curated databases, and model repositories. The servers 108 may execute complementary processes such as large-scale model training, reinforcement learning updates, or metadata aggregation, while the recursive generative planning apparatus 104 performs localized inference and verification operations. Through this networked configuration, recursive pathway generation tasks may be distributed across multiple nodes, allowing high-throughput exploration of transformation pathways for both organic and inorganic systems. The data network 106 enables real-time synchronization of user feedback, validation outcomes, and metadata between the recursive generative planning apparatus 104 and the servers 108, thereby facilitating adaptive refinement of model parameters, coordinated execution of complex generative-discriminative workflows, and secure storage of verified pathway data for subsequent retrieval or analysis.

In certain embodiments, the recursive generative planning apparatus 104 interfaces with one or more information handling devices 102 that provide the primary user interaction environment for human-in-the-loop operation. Through these devices, users may submit target structures, review generated transformation pathways, and provide corrective or directional feedback to guide the recursive planning pipeline executed by the recursive generative planning apparatus 104. The information handling devices 102 may display molecular or material structures, simulation outputs, or performance metrics through graphical user interfaces, and may transmit user inputs—such as structural edits, pathway exclusions, or validation overrides—to the recursive generative planning apparatus 104 in real time. This bidirectional communication enables selective regeneration of pathway segments without recomputation of validated results and supports adaptive refinement of generative and rule-based model behavior based on expert input. In certain embodiments, portable or remote information handling devices 102, such as tablets or workstations, may access the recursive generative planning apparatus 104 through secure network connections, allowing domain specialists to interactively evaluate and refine transformation pathways for applications including low-k dielectric development, natural product synthesis, and metal-organic framework design.

In certain embodiments, the recursive generative planning apparatus 104 exposes a configuration interface enabling user-defined constraints and resources for pathway generation. The interface may accept a stock inventory of available starting materials and reagents; one or more expansion policies that govern pathway branching; a filter model to exclude infeasible proposals; explicit starting materials; exclusion lists for reaction types and reagents; and numeric bounds such as minimum/maximum pathway length, number of alternative pathways to return, and minimum yield thresholds. These parameters are consumed by the system control module 214 and enforced across the generative model module 202, rule-based model module 204, and verification module 206 during recursive execution.

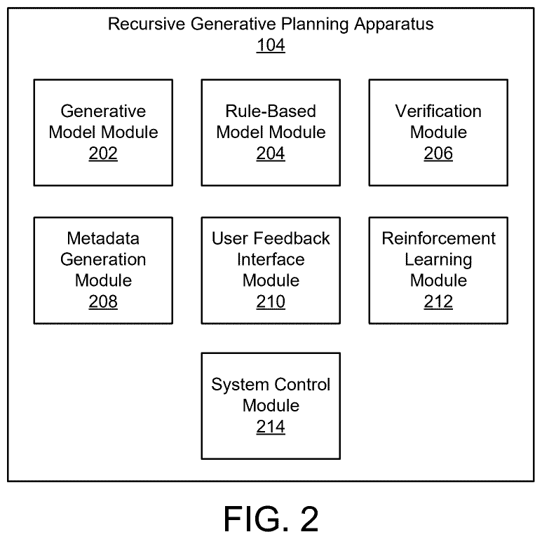

FIG. 2 depicts one embodiment of an apparatus for recursive generative planning and pathway validation. In one embodiment, the apparatus includes an instance of a recursive generative planning apparatus 104. The recursive generative planning apparatus 104, in one embodiment, includes one or more of a generative model module 202, a rule-based model module 204, a verification module 206, a metadata generation module 208, a user feedback interface module 210, a reinforcement learning module 212, and a system control module 214. Each module may be implemented as software instructions executed by one or more processors, hardware logic, firmware, or any combination thereof.

In general, the generative model module 202 and the rule-based model module 204 cooperatively generate and refine candidate transformation pathways for a given target structure. The verification module 206 applies validity, stability, and coherence checks to intermediate outputs, while the metadata generation module 208 augments verified pathways with reagent, condition, and literature information. The user feedback interface module 210 enables partial regeneration and expert guidance, and the reinforcement learning module 212 continuously updates decision policies based on accumulated feedback and validation data. The system control module 214 coordinates communication among modules and manages distributed execution across networked computing resources.

In operation, the modules of the recursive generative planning apparatus 104 cooperate within a recursive planning pipeline that iteratively generates, evaluates, and refines transformation pathways. The generative model module 202 receives a target structure and proposes one or more candidate precursor transformations using probabilistic or learned representations. The rule-based model module 204 concurrently or subsequently applies deterministic templates or transformation rules to verify and constrain the generative proposals, ensuring chemical or structural plausibility. Intermediate outputs from these modules are routed to the verification module 206, which evaluates their validity, stability, and coherence using domain-specific validators tailored for organic and inorganic molecular systems. Validated results are annotated by the metadata generation module 208, which associates each pathway segment with contextual data such as reagents, reaction conditions, and supporting literature references. Through the user feedback interface module 210, experts may edit or approve intermediate outputs, triggering partial regeneration of sub-pathways while preserving verified segments. The reinforcement learning module 212 monitors these interactions and progressively refines the generative and rule-based models based on validation outcomes and user guidance. The system control module 214 orchestrates data exchange among modules, manages distributed execution across server nodes, and synchronizes updates to maintain consistency of the recursive generative-discriminative workflow.

The recursive planning pipeline executed by the recursive generative planning apparatus 104 operates as a closed-loop generative-discriminative system in which outputs from one stage are iteratively reintroduced as inputs for subsequent refinement. In one embodiment, the pipeline begins when the generative model module 202 produces a set of initial transformation candidates for a given target structure. The rule-based model module 204 evaluates these candidates using domain-specific transformation templates and symbolic constraints, yielding intermediate outputs that represent partial or complete transformation pathways. These intermediate outputs are analyzed by the verification module 206, which filters or scores them according to structural validity, energetic stability, and logical coherence criteria. The verified pathways are then recorded and enriched by the metadata generation module 208, while lower-confidence pathways are reintroduced into the generative process for recursive exploration. At any stage, a user may interact with the user feedback interface module 210 to direct pathway regeneration, correct model outputs, or impose design constraints. The reinforcement learning module 212 monitors the outcomes of each iteration, adjusting model parameters and pathway selection policies based on accumulated feedback and performance metrics. The entire cycle is coordinated by the system control module 214, which manages execution dependencies, resource allocation across distributed nodes, and synchronization of recursive iterations to ensure convergence toward validated, high-confidence transformation pathways. Feedback and verification occur at each recursion step, enabling continuous, step-wise adjustment.

In one embodiment, the generative model module 202 is configured to propose candidate transformation pathways or precursor structures for a target molecule, material, or device configuration. In one embodiment, the generative model module 202 employs one or more LLMs, graph neural networks (GNNs), or other transformer-based architectures trained on diverse molecular, structural, or materials datasets. The generative model module 202 may generate multiple transformation hypotheses by decomposing the target structure into smaller substructures or precursors, estimating feasible reaction or assembly sequences, or predicting molecular modifications. The generative model module 202 may operate probabilistically, outputting several high-likelihood candidates along with confidence metrics. Each generated pathway or structure is passed to the rule-based model module 204 for deterministic evaluation and constraint enforcement. The generative model module 202 may also receive feedback from the reinforcement learning module 212 to bias subsequent generations toward transformations or structural motifs that have been validated in previous iterations.

In one embodiment, the rule-based model module 204 serves as a deterministic counterpart to the generative model module 202, enforcing chemical, physical, and logical constraints on proposed transformations. In one embodiment, the rule-based model module 204 implements a library of reaction templates, transformation grammars, or structural heuristics derived from known reaction mechanisms or materials assembly rules. For inorganic systems, such as semiconductor film precursors or MOFs, the rule-based model module 204 may further incorporate geometric and coordination rules that govern bonding topology, lattice alignment, or metal-ligand compatibility. The rule-based model module 204 verifies whether the outputs of the generative model module 202 conform to one or more of these rules, rejecting or modifying pathways that violate physical constraints. It may also independently generate alternative deterministic transformations, which are later reconciled with generative proposals through a race condition or selection process managed by the system control module 214.

In one embodiment, the verification module 206 evaluates the intermediate outputs from the generative and rule-based model modules to ensure validity, stability, and coherence before they advance through the recursive pipeline. In one embodiment, the verification module 206 includes a validity checker, a stability checker, and a coherence checker. The validity checker confirms that predicted molecular structures or materials configurations comply with established bonding patterns, stoichiometric constraints, or electronic valence rules. The stability checker performs energetic assessments using embedded physics-based or machine-learning-based potential models, screening out metastable or thermodynamically unfavorable configurations.

The coherence checker identifies hallucinated or logically inconsistent transformations—such as nonphysical atom rearrangements or contradictory structural motifs—and removes or flags them for review. In certain implementations, the verification module 206 applies domain-specific validators, allowing separate validation criteria for organic and inorganic systems, including stereochemical evaluation for organic molecules and coordination-geometry validation for inorganic materials. Results from the verification module 206 are transmitted to the metadata generation module 208 and to the reinforcement learning module 212 for further processing. The verification module 206 may generate structured feedback describing invalid, duplicate, unstable, or incoherent intermediates, which the generative model module 202 consumes to reduce repeated errors and bias proposals toward higher scalability scores in subsequent iterations. In some embodiments, the verification module 206 exposes user-selectable toggles to enable or disable individual checkers (e.g., hallucination and stability) for debugging or ablation studies.

In one embodiment, the metadata generation module 208 enriches verified transformation pathways with descriptive, contextual, and bibliographic information. In one embodiment, the metadata generation module 208 automatically annotates each step in a pathway with reagent identifiers, reaction conditions, kinetic or thermodynamic parameters, and corresponding literature or patent references retrieved from internal or external databases. For inorganic applications, the metadata generation module 208 may associate validated pathways with process conditions such as temperature, pressure, and precursor vapor composition relevant to thin-film deposition or crystal growth. The metadata may further include provenance information linking each transformation to its originating model and verification outcome, ensuring traceability and reproducibility. This metadata enables downstream analysis, facilitates laboratory implementation, and provides structured datasets for retraining the generative and rule-based modules. The metadata generation module 208 communicates continuously with the verification module 206 and reinforcement learning module 212 to maintain synchronization between validated outputs and their descriptive records.

In certain embodiments, the metadata generation module 208 comprises: (i) a reagent identification agent that proposes compatible reagents and substitutions; (ii) a reaction-condition determination subsystem that estimates temperature, pressure, solvent systems, duration, and safety protocols, with iterative refinement; (iii) a literature-evidence integration subsystem that retrieves precedent reactions and patents, computes coverage-based confidence, and generates citations; and (iv) an integration engine that cross-validates and formats standardized procedure documentation associated with nodes of the pathway graph.

In one embodiment, the user feedback interface module 210 enables direct human interaction with the recursive planning process. Through the user feedback interface module 210, users may visualize intermediate structures, inspect transformation sequences, and input corrections or design preferences. In one embodiment, the user interface presents candidate pathways in graphical or textual form, permitting operations such as simplified molecular input line entry system (SMILES) string editing, structure dragging and dropping, or exclusion of specific reaction types. When a user provides feedback, the interface module 210 communicates those inputs to the system control module 214, which triggers partial regeneration of affected sub-pathways while preserving verified segments. The user feedback interface module 210 may also log user actions for later analysis by the reinforcement learning module 212. In distributed implementations, the user feedback interface module 210 supports secure remote interaction via the data network 106, allowing domain experts—such as synthetic chemists, materials scientists, or semiconductor process engineers—to guide the generative-discriminative process in real time.

The user feedback interface module 210 may implement a two-phase intervention protocol comprising a hallucination-correction phase—permitting direct structure editing (e.g., SMILES) with immediate validity checks—and a pathway-redirection phase that accepts natural-language guidance to prefer or exclude reaction classes, solvents, or conditions. In certain embodiments, the module supports multi-pathway regeneration from a selected node, concurrently generating several alternatives for side-by-side comparison and selection

In one embodiment, the reinforcement learning module 212 is configured to optimize pathway generation and model coordination through iterative learning. The reinforcement learning module 212 may implement a policy network that predicts optimal actions for pathway expansion and a value network that estimates expected rewards for each candidate transformation or decision. During operation, the reinforcement learning module 212 receives validation results, user feedback data, and metadata annotations to construct a reward function that quantifies pathway quality based on validity, stability, scalability, and alignment with user-specified constraints. The reinforcement learning module 212 uses this feedback to refine both the generative model module 202 and the rule-based model module 204, gradually improving accuracy and efficiency across recursive iterations. In some embodiments, the reinforcement learning module 212 operates continuously, adapting to new molecular domains and expanding its decision space to handle both organic and inorganic transformation logic.

The reinforcement learning module 212 may define a reward function that balances synthetic feasibility, predicted or literature-derived yield, number of steps, reagent availability and cost, and compliance with user constraints. Training signals include pathway selections, partial-rerun choices, rejection criteria, direct molecular corrections, and natural-language guidance captured during human-in-the-loop operation

In one embodiment, the system control module 214 orchestrates communication, synchronization, and execution scheduling among the other modules of the recursive generative planning apparatus 104. The system control module 214 manages the recursive flow of data between generative and discriminative components, monitors the state of ongoing computations, and handles distributed execution across local and remote servers 108. In one embodiment, the system control module 214 also manages task allocation across multiple worker nodes and prioritizes pathway evaluations based on scalability index, confidence score, or number of transformation steps. The system control module 214 ensures that regenerated sub-pathways seamlessly integrate into validated pathways and that verification results and metadata remain consistent across iterations. The system control module 214 further interfaces with the data network 106 to transmit results, synchronize model updates, and enforce data integrity and security across the recursive generative planning framework.

In one embodiment, the recursive generative planning process executed by the recursive generative planning apparatus 104 continues iteratively until one or more termination criteria are satisfied. In one embodiment, the system control module 214 determines convergence based on a combination of factors, including achievement of a complete transformation pathway in which all leaf precursors are present in a specified stock inventory from available precursor materials, attainment of a defined confidence or reward threshold, or exhaustion of viable recursive expansions. When a valid pathway is confirmed, the verification module 206 performs a final validation pass to ensure consistency across all intermediate outputs. The metadata generation module 208 then compiles a comprehensive record of the final pathway, including reagent specifications, reaction or process conditions, yield estimates, and bibliographic references. The completed dataset is stored locally or transmitted to the servers 108 for archiving, analysis, or deployment in downstream applications such as simulation, fabrication, or experimental synthesis. In certain embodiments, partial or alternative pathways that meet sub-threshold criteria may also be retained to expand the training corpus for the reinforcement learning module 212, enabling continual improvement of the recursive generative-discriminative system over time.

The verified transformation pathways produced by the recursive generative planning apparatus 104 may be used in a variety of downstream computational and experimental applications. In one embodiment, the verified pathways serve as digital blueprints for chemical synthesis, materials fabrication, or process design. For example, in the context of low-k dielectric development, the recursive generative planning apparatus 104 may identify and validate novel precursor molecules and deposition sequences that yield materials with targeted dielectric constants and thermal stability. In other embodiments, the verified pathways may define synthetic routes for organic molecules, natural products, or coordination structures such as MOFs. The metadata generated for each pathway enables direct integration with laboratory automation systems, simulation platforms, and electronic laboratory notebooks, ensuring that all reaction conditions, precursor identities, and validation data are traceable and reproducible. The verified pathways may also be aggregated across multiple executions of the recursive generative planning apparatus 104 to populate knowledge bases or model training datasets that improve generative accuracy and predictive capability in subsequent iterations.

In certain embodiments, multiple instances of the recursive generative planning apparatus 104 may be deployed across a distributed computing environment to support scalable, high-throughput execution of recursive generative planning workflows. Each instance may operate as a worker node configured to process one or more transformation pathways, while a coordinating head node manages task allocation, load balancing, and inter-node communication. In certain embodiments, a head node loads a configuration file specifying execution policies, prioritization metrics, and checker settings distributed to worker nodes at job start. The head node may prioritize pathway execution based on scalability index, confidence score, or pathway length, ensuring efficient utilization of computational resources across heterogeneous workloads. Execution prioritization may incorporate a scalability score emitted with pathway candidates, and the system may leverage hardware accelerators for inference to improve throughput. The distributed configuration enables simultaneous exploration of numerous target structures, materials systems, or precursor combinations, with each recursive generative planning apparatus 104 independently executing localized validation and metadata generation. Results from each apparatus are aggregated through the data network 106 and synchronized by the system control module 214 to maintain global consistency across the recursive generative-discriminative framework. This architecture allows the system to dynamically adjust recursion depth, model selection, and node allocation in response to target complexity or available computational capacity, thereby achieving near-linear scalability for large-scale materials discovery and design initiatives.

In certain embodiments, user feedback and reinforcement learning updates generated by each instance of the recursive generative planning apparatus 104 are aggregated into a shared adaptive knowledge base to continuously improve system performance across distributed deployments. Each apparatus instance records user interactions, pathway selections, verification outcomes, and metadata associations, transmitting this data to one or more central servers 108 for consolidation. The reinforcement learning module 212 may then derive global policy and value updates that capture cross-domain expertise from organic, inorganic, and hybrid material systems. These updated model parameters and reward functions are periodically propagated back to each apparatus instance through the data network 106, enabling synchronized learning and improved generative-discriminative balance across the entire network. This federated training approach ensures that advances made in one domain—such as coordination geometry validation for metal-organic frameworks or precursor stability analysis for low-k dielectric films—enhance predictive capability in related applications. As a result, the recursive generative planning apparatus 104 network evolves toward a self-optimizing architecture that benefits from cumulative human feedback and distributed experiential learning.

The system may further include a data management and version control infrastructure configured to archive, index, and retrieve outputs generated by the recursive generative planning apparatus 104 and associated modules. In one embodiment, each validated transformation pathway, along with its corresponding metadata and verification records, is assigned a unique digital identifier that encodes the pathway's lineage, generative source, and validation history. These identifiers enable traceability of each pathway through successive recursive iterations and across multiple apparatus instances. The data management infrastructure may maintain versioned repositories that store successive generations of the generative and rule-based models, associated training datasets, and user feedback logs. Such versioning ensures that results can be reproduced under defined model conditions and that incremental improvements can be audited or rolled back if necessary. Metadata generated by the metadata generation module 208 may be indexed in searchable databases accessible through the data network 106, enabling researchers to query verified transformation pathways based on molecular class, material property, synthesis condition, or performance metric. This structured data architecture supports regulatory compliance, intellectual property management, and reproducibility standards while enabling efficient integration with external laboratory, simulation, and knowledge management systems.

In certain embodiments, the distributed network of recursive generative planning apparatuses 104 employs a secure data management framework to maintain integrity, confidentiality, and controlled access to all generated data, models, and metadata. Communications among apparatus instances, servers 108, and information handling devices 102 may be encrypted using industry-standard or quantum-resistant cryptographic protocols to protect sensitive intellectual property and proprietary material data. Access to verified transformation pathways and associated metadata may be governed by multi-factor authentication, role-based authorization, and hierarchical permissions that restrict modification privileges to authorized users or system administrators. Integrity verification mechanisms—such as cryptographic hashing or blockchain-backed transaction logs—may be used to ensure that pathway data, model parameters, and user feedback records remain unaltered once validated. The system control module 214 may further enforce audit logging and digital signing of all operations, enabling traceable lineage of both human and machine contributions across recursive iterations. This secure and verifiable infrastructure provides confidence that the distributed recursive generative planning framework can be deployed for collaborative research, industrial design, or regulatory-sensitive applications while preserving data provenance and intellectual property integrity.

The recursive generative planning apparatus 104 may be implemented in a variety of deployment modes depending on computational requirements, security policies, and application domains. In one embodiment, the recursive generative planning apparatus 104 may be embodied as a dedicated on-premise hardware appliance integrated into a laboratory or manufacturing environment, providing localized execution of generative and verification workflows where data confidentiality or low-latency operation is required. In other embodiments, the apparatus may be deployed as a virtualized or containerized service within a cloud computing infrastructure, allowing elastic scaling of model execution and distributed access for remote collaborators. A hybrid configuration may also be used, wherein on-premise instances perform primary inference and validation tasks while cloud-based instances execute large-scale reinforcement learning, model retraining, or metadata aggregation. In yet other embodiments, lightweight versions of the recursive generative planning apparatus 104 may be embedded at the network edge or within specialized hardware, such as semiconductor process controllers or materials characterization instruments, to perform localized inference and real-time decision support. Each deployment mode may communicate through the data network 106 with central servers 108 for synchronization, model updates, and federated learning, thereby maintaining consistency and shared intelligence across heterogeneous environments.

The recursive generative planning apparatus 104 may be applied across a broad range of scientific and industrial domains where automated discovery and validation of transformation pathways are desirable. In one embodiment, the recursive generative planning apparatus 104 facilitates organic synthesis of complex molecules, including natural products and pharmaceutical intermediates, by generating retrosynthetic pathways that incorporate stereochemical accuracy, protecting-group strategies, and reaction condition optimization. In another embodiment, the recursive generative planning apparatus 104 supports inorganic and hybrid materials design, such as the identification and synthesis of semiconductor film precursors for low-k dielectric materials or the assembly of MOFs with targeted porosity, stability, and adsorption characteristics. The recursive generative planning apparatus 104 may also be used in catalyst discovery, battery electrode formulation, polymer design, and other applications requiring coordinated molecular or structural planning. By integrating generative and rule-based reasoning with domain-specific validators and metadata generation, the recursive generative planning apparatus 104 enables accelerated identification of viable synthesis routes, enhances reproducibility across laboratories, and reduces the experimental iteration burden typically associated with complex materials and molecular development.

The recursive generative planning apparatus 104 provides an improvement over conventional LLM-only and rule-based synthesis systems by unifying probabilistic generative reasoning with deterministic validation and adaptive learning in a single recursive framework. Traditional rule-based planners are constrained by limited template coverage and cannot generalize to novel chemical or materials systems, while purely generative models often produce unstable, nonphysical, or hallucinatory outputs that lack chemical validity. By integrating these approaches, the recursive generative planning apparatus 104 achieves controlled generation that is both creative and verifiable. The recursive structure allows iterative refinement of candidate pathways based on user feedback and model self-evaluation, leading to progressively higher accuracy and convergence efficiency. The incorporation of domain-specific validators and metadata generation ensures applicability to both organic and inorganic systems, while distributed execution across multiple apparatus instances provides scalability suitable for industrial and research-grade discovery platforms. Collectively, these capabilities enable the recursive generative planning apparatus 104 to serve as a self-improving, cross-domain engine for synthesis design, materials optimization, and transformation pathway prediction.

In some embodiments, the recursive pipeline employs alternative decision mechanisms. In a race-condition mode, the rule-based model module 204 and the generative model module 202 independently propose next-step transformations, and a selection subroutine of the system control module 214 (optionally implemented as a decider LLM) selects a candidate based on confidence and verification scores. In another embodiment, multiple pathways emitted by the generative model module 202 are expanded in parallel to form a search tree, with the system control module 214 applying tree-search or Monte Carlo tree search (MCTS) heuristics to select a path. In further embodiments, a graph neural network (GNN) retrosynthesis engine may substitute for or complement template/MCTS functions within the rule-based model module 204.

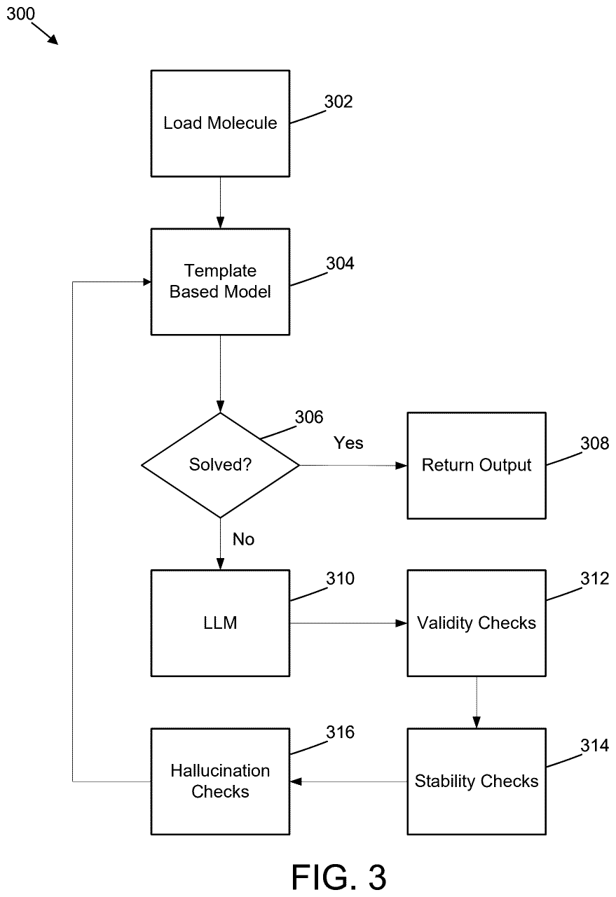

FIG. 3 depicts one embodiment of a recursive generative planning workflow 300 executed by the recursive generative planning apparatus 104. In one embodiment, the workflow 300 illustrates the operation of the recursive planning pipeline implemented by the apparatus 104 and its associated modules.

As shown in FIG. 3, the workflow begins at a load molecule block 302, where the system control module 214 retrieves a target molecular or material structure from memory or user input via the user feedback interface module 210. The structure may be represented in a standardized format, such as a SMILES string, or in a graph-based molecular representation. The system control module 214 initializes a new recursive planning instance for the target structure and transmits the data to the generative and rule-based processing components.

The target structure is then processed by a template-based model block 304, which corresponds to the rule-based model module 204 of the recursive generative planning apparatus 104. In one embodiment, the rule-based model module 204 applies deterministic reaction templates, transformation grammars, or structural heuristics to attempt generation of a complete or partial transformation pathway for the target structure. These templates may be derived from chemical reaction mechanisms, lattice coordination rules, or structural assembly patterns depending on whether the system is operating in an organic or inorganic domain.

The output from the template-based model block 304 is passed to a decision node 306, labeled “Solved?”, which determines whether a valid transformation pathway satisfying predefined validity and stability thresholds has been obtained. The decision node 306 is implemented by the system control module 214 in cooperation with the verification module 206, which evaluates intermediate results according to domain-specific validation criteria. If the result satisfies all thresholds, the process proceeds to the return output block 308.

At the return output block 308, the recursive generative planning apparatus 104 records the validated pathway and associated metadata. The metadata generation module 208 annotates the pathway with reagent identifiers, reaction conditions, energetic data, and literature references, while the system control module 214 archives the complete result for user review or downstream simulation.

If the decision node 306 determines that the pathway is unsolved or incomplete, control passes to an LLM-based generation block 310, corresponding to the generative model module 202. The generative model module 202 proposes one or more precursor structures or transformations using probabilistic reasoning and trained language-model embeddings. These candidate pathways are output with associated confidence scores and explanatory context.

The results from the LLM-based generation block 310 are transmitted to a validity check block 312, implemented by the verification module 206. The validity check block 312 confirms that each generated intermediate or reaction step satisfies chemical and structural rules, such as atom valence, bonding topology, and stoichiometric balance. Invalid intermediates are discarded, while valid ones are passed downstream.

Validated outputs proceed to a stability check block 314, also executed by the verification module 206, where each intermediate is evaluated for energetic feasibility and physical stability. The stability checker may use molecular mechanics calculations, density functional approximations, or data-driven potential models to eliminate unstable configurations.

Following the stability evaluation, the process advances to a hallucination check block 316, implemented by the verification module 206 in conjunction with the reinforcement learning module 212. This block identifies artifacts or implausible transformations introduced by the generative model module 202, such as missing atoms, nonphysical rearrangements, or disconnected fragments, and removes or corrects them. The reinforcement learning module 212 records such corrections to improve future model performance.

Outputs that pass the verification sequence are recursively reintroduced into the planning pipeline through a recursive feedback connection 318. This connection represents the cyclic data flow managed by the system control module 214, which resubmits validated intermediates to the template-based model block 304 and the LLM-based generation block 310 as new targets. The recursive feedback connection 318 allows progressive refinement of pathways until complete and verified routes are generated.

Throughout this process, the user feedback interface module 210 allows users to intervene by selecting intermediates, editing structures, or constraining transformation rules at any stage of the workflow 300. User inputs are integrated into the recursive loop via the system control module 214, enabling targeted regeneration of pathway segments without recomputation of previously validated results.

In operation, the workflow 300 illustrated in FIG. 3 demonstrates how the recursive generative planning apparatus 104 unifies generative reasoning, deterministic modeling, and multi-stage validation within a closed recursive framework. This configuration enables adaptive and verifiable pathway discovery for organic, inorganic, and hybrid molecular systems, supporting applications in synthetic chemistry, semiconductor materials design, and metal-organic framework development.

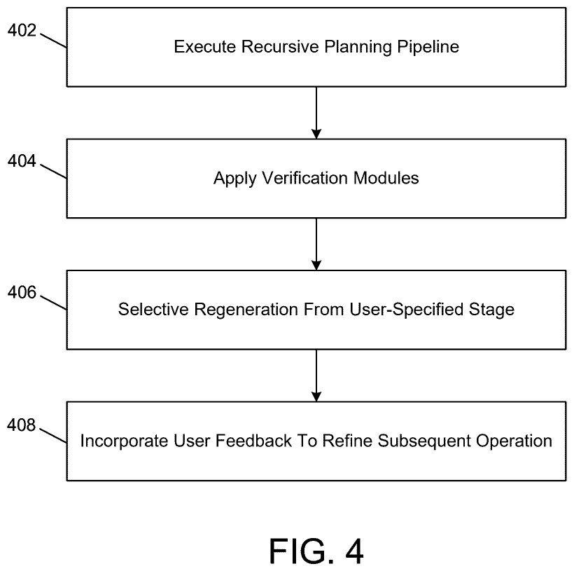

FIG. 4 depicts one embodiment of a method for recursive generative planning system with verification modules and user feedback integration. In one embodiment, the method may be performed by an information handling device 102, a server 108, a generative model module 202, a rule-based model module 204, a verification module 206, a metadata generation module 208, a user feedback interface module 210, a reinforcement learning module 212, and a system control module 214.

In one embodiment, the method begins when the system control module 214 initializes a recursive planning pipeline within the recursive generative planning apparatus 104. The system control module 214 loads the target molecular or material structure from memory or user input, retrieves any applicable configuration parameters (e.g., expansion policy, stock inventory, or reaction exclusions), and initiates the first iteration of pathway generation.

The generative model module 202 proposes one or more precursor transformations or decompositions of the target structure using probabilistic reasoning, embeddings, or graph-based prediction. Simultaneously, the rule-based model module 204 applies deterministic reaction templates, symbolic rules, or transformation grammars to verify or supplement generative outputs. The system control module 214 merges, ranks, or prunes overlapping results and transmits the resulting intermediate outputs to the verification stage.

This cooperative step ensures that both generative and deterministic reasoning are applied in parallel, allowing the system to produce transformation hypotheses that are both novel and chemically or structurally valid.

In step 404, the verification module 206 performs multi-stage validation on the intermediate outputs received from step 402. The verification process includes, but is not limited to:
Validity Checking: Each intermediate structure is evaluated to ensure compliance with bonding rules, valence constraints, stoichiometry, and topological integrity.
Stability Checking: The verification module 206 applies predictive energetic or thermodynamic models to estimate structural stability and discard metastable or nonphysical intermediates.
Coherence Checking: The verification module 206, optionally supported by the reinforcement learning module 212, detects hallucinated or logically inconsistent transformations—such as disconnected atoms, cyclic impossibilities, or unbalanced reactions—and filters them from further analysis.

The verification results are passed back to the system control module 214 for scoring, ranking, and decision-making. Candidates that meet or exceed defined thresholds are retained for potential output or recursive reanalysis.

This stage ensures that only transformations satisfying chemical, energetic, and logical requirements continue through the recursive loop, thereby improving accuracy and minimizing computational waste.

At step 406, the method allows targeted regeneration of pathway segments without recomputing the entire pathway. The user feedback interface module 210 presents the currently generated retrosynthetic or transformation tree to the user, highlighting validated and unvalidated segments. The user may identify a node or subpath that requires refinement—such as an implausible intermediate or a low-yield reaction.

Upon receiving the selection, the system control module 214 isolates the chosen node, preserves validated segments upstream of it, and triggers regeneration of only the affected portion of the pathway. The regeneration process may reuse the generative model module 202 and rule-based model module 204 to propose alternative transformations while maintaining contextual consistency with the rest of the pathway.

This selective regeneration mechanism significantly reduces computational overhead by preventing full pathway recomputation and allows domain experts to inject targeted corrections in real time, thereby improving both efficiency and human-machine collaboration.

At step 408, the user feedback interface module 210 records and transmits user inputs—such as structural corrections, preferred reaction mechanisms, disallowed reagents, or other design constraints—to the system for incorporation into subsequent recursive cycles.

The reinforcement learning module 212 processes these feedback events along with the validation outcomes generated in step 404 to update policy and value networks. These updates inform how the generative model module 202 and rule-based model module 204 prioritize or prune future pathway suggestions. The system control module 214 synchronizes these model updates across distributed instances of the recursive generative planning apparatus 104 to ensure consistent learning behavior.

Through this continuous feedback integration, the system evolves adaptively: the next recursion executes with improved generative bias, reduced hallucination rates, and higher pathway quality. The loop from step 402 through step 408 may repeat until a complete and validated transformation pathway is generated or until user-defined termination criteria are met (e.g., all precursors present in stock inventory or confidence threshold achieved).

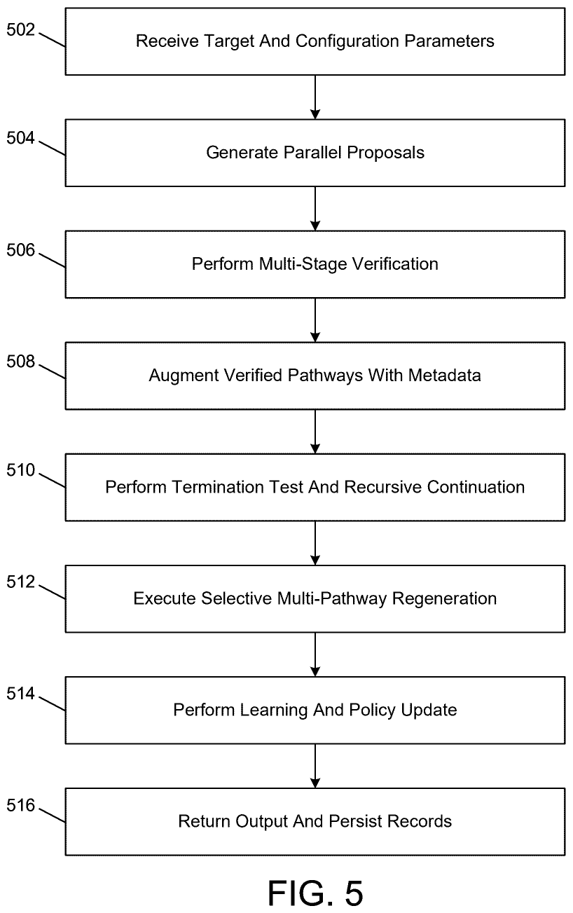

FIG. 5 depicts one embodiment of a method for recursive generative planning system with verification modules and user feedback integration. In one embodiment, the method may be performed by an information handling device 102, a server 108, a generative model module 202, a rule-based model module 204, a verification module 206, a metadata generation module 208, a user feedback interface module 210, a reinforcement learning module 212, and a system control module 214.

In one embodiment, the method begins when the system control module 214, in conjunction with the user feedback interface module 210, receives a target structure and any accompanying configuration data. The configuration may include user-specified parameters such as:
stock inventories of available reagents or starting materials,
reaction expansion policies defining the branching behavior of the recursive search,
exclusion lists for reactions or reagents,
minimum and maximum pathway lengths or number of steps, and
yield or confidence thresholds for valid pathways.

The system control module 214 parses these inputs and initializes an instance of the recursive generative planning workflow tailored to the supplied parameters. The target structure is stored in memory and made available to the generative model module 202 and rule-based model module 204 for further processing.

At step 504, the generative model module 202 and the rule-based model module 204 independently generate candidate transformations for the target structure. The generative model module 202 uses probabilistic or deep-learning-based reasoning to suggest novel precursor structures or reaction sequences, while the rule-based model module 204 applies deterministic transformation templates or Monte Carlo Tree Search (MCTS) heuristics to derive classical retrosynthetic routes.

The system control module 214 operates in a “race condition” mode, wherein both sets of proposals are evaluated in parallel. A decision subroutine or decider network may select one or more candidate pathways based on preliminary confidence scores, reaction feasibility, or alignment with user constraints. This parallel generation strategy allows the system to balance creativity and reliability, improving diversity and coverage of proposed pathways.

In step 506, the selected candidate transformations are transmitted to the verification module 206 for comprehensive evaluation. This module applies a multi-stage verification process similar to that described in FIG. 4, step 404, including:
Validity Checking—confirming structural correctness and stoichiometric balance;
Stability Checking—computing or predicting thermodynamic and kinetic stability; and
Coherence Checking—detecting hallucinated or logically inconsistent transformations.

The verification module 206 may apply domain-specific criteria, with separate evaluators for organic systems (e.g., stereochemistry, functional group compatibility) and inorganic systems (e.g., coordination geometry, lattice strain). Pathways that pass the verification thresholds proceed to metadata annotation in step 508, while failing pathways are either discarded or returned to the generative model module 202 for correction in the next recursive cycle.

At this stage, the metadata generation module 208 annotates the validated transformation pathways with contextual, experimental, and bibliographic information. The metadata may include:
reagent identities, recommended concentrations, and molar ratios;
reaction or process conditions such as temperature, pressure, solvent, and duration;
yield predictions or energy profiles; and
citations to precedent reactions or patents.

The metadata generation module 208 may further include subsystems for reagent identification, condition determination, literature evidence integration, and metadata consistency checking. The resulting enriched records are returned to the system control module 214 and stored for traceability, simulation, or later reinforcement learning.

In step 510, the system control module 214 determines whether the recursive generative planning process should continue or terminate. Termination criteria may include:
all terminal precursors are found in the user-specified stock inventory,
the overall pathway confidence or reward value exceeds a defined threshold, or
no further viable transformations remain.

If termination criteria are not met, the system control module 214 initiates another recursive iteration, treating verified intermediates from the current cycle as new targets and returning control to step 504. This recursive feedback loop allows iterative refinement of pathways, progressive error correction, and deeper exploration of chemical or material transformation space.

When a user intervenes or when the system identifies low-confidence segments, the method may invoke step 512, in which the user feedback interface module 210 and the system control module 214 enable partial rerun of specific pathway branches. In this embodiment, multiple alternative regeneration threads may be spawned in parallel, each producing a distinct sub-pathway for comparison.

The system control module 214 coordinates the regeneration requests and ensures that validated segments from prior iterations are preserved. The regenerated pathways are revalidated by the verification module 206, with successful variants incorporated into the active retrosynthetic graph. This capability allows domain experts to explore alternative strategies efficiently without recomputing the entire solution tree.

At step 514, the reinforcement learning module 212 processes feedback from all preceding stages to refine internal decision policies and value estimates. The module aggregates data including:
user interventions from the user feedback interface module 210,
validation outcomes from the verification module 206,
metadata annotations from the metadata generation module 208, and
final success metrics from the system control module 214.

The reinforcement learning module 212 may employ imitation learning during early operation, reinforcement learning during self-play, and continuous learning during long-term deployment. The updated policy and value networks are transmitted back to the generative model module 202 and rule-based model module 204, biasing future iterations toward pathways with higher stability, yield, and scalability scores.

Upon successful convergence, the process reaches step 516, where the system control module 214 finalizes the validated transformation pathway and orchestrates persistent storage of all associated data. The metadata generation module 208 completes any remaining annotations and assigns unique digital identifiers to the pathway for traceability. The final output may be transmitted to the user feedback interface module 210 for visualization or exported to external laboratory, simulation, or manufacturing systems for implementation.

The system control module 214 may additionally archive the pathway, metadata, and verification logs within a distributed database or version-controlled repository, enabling later retrieval, reproducibility, or inclusion in retraining datasets. The process 500 then terminates or optionally continues into a new cycle if further optimization criteria are defined by the user or the reinforcement learning module 212.

In one embodiment, an apparatus is configured to execute a recursive planning pipeline that integrates at least one generative model and at least one rule-based model to generate candidate transformation pathways for a target structure, apply one or more verification modules to evaluate validity, stability, and coherence of intermediate outputs, selectively regenerate portions of the candidate transformation pathways from a user-specified stage while preserving validated portions, and incorporate user feedback to refine subsequent pathway generation and model operation.

In one embodiment, the candidate transformation pathways comprise alternative multi-step sequences representing transformations between a target structure and one or more precursor structures, wherein each candidate transformation pathway is characterized by at least one transformation rule, reaction template, or model-generated operation connecting intermediate states within the sequence.

In one embodiment, the intermediate outputs comprise representations of partial transformations or precursor structures generated at successive stages of the recursive planning pipeline, wherein the intermediate outputs are evaluated for structural validity, energetic stability, or logical consistency prior to continuation of the pipeline.

In one embodiment, the one or more verification modules comprise a validity checker configured to evaluate chemical or structural correctness of the intermediate outputs, a stability checker configured to assess energetic or functional stability, and a coherence checker configured to detect or mitigate hallucinated or implausible transformations produced by the generative model.

In one embodiment, the apparatus is configured to receive user feedback through at least one interface to modify or constrain model operation, wherein the user feedback comprises corrections to structural representations, exclusion of specified transformation types, or directional guidance for alternative pathway exploration.

In one embodiment, the apparatus is configured to regenerate a portion of the candidate transformation pathways from a user-selected stage within the recursive planning pipeline while retaining preceding validated pathway segments, thereby enabling targeted refinement without full recomputation of the candidate transformation pathways.

In one embodiment, the apparatus is configured to record user feedback and verification outcomes to update model parameters or decision policies, thereby enabling adaptive improvement of subsequent pathway generation operations.

In one embodiment, the recursive planning pipeline is executed across a distributed computing architecture comprising a head node configured to manage task allocation and a plurality of worker nodes configured to concurrently process candidate transformation pathways for different target structures or recursive stages. In one embodiment, the head node prioritizes pathway execution based on one or more metrics including scalability index, confidence score, or number of transformation steps.

In one embodiment, the apparatus includes a reinforcement learning agent configured to optimize pathway generation decisions based on accumulated user interactions, pathway validation results, and system performance metrics. In one embodiment, the reinforcement learning agent comprises a policy network configured to predict optimal actions for pathway expansion and a value network configured to estimate expected rewards associated with candidate pathways. In one embodiment, the reinforcement learning agent is trained using imitation learning from expert user interactions and reinforcement learning through autonomous exploration of pathway generation outcomes.

In one embodiment, the apparatus includes a metadata generation subsystem configured to augment each transformation pathway with information including reagent identification, reaction condition determination, and literature evidence correlation. In one embodiment, the metadata generation subsystem retrieves precedent reactions, patent data, or publication references and associates corresponding citations with nodes of the transformation pathway.

In one embodiment, the recursive planning pipeline is configured to generate transformation pathways for both organic and inorganic molecular systems, including natural products, semiconductor film precursors, and metal-organic frameworks. In one embodiment, the one or more verification modules and the metadata generation subsystem are each configured to apply domain-specific validation and annotation protocols for organic and inorganic molecular systems, including validation of coordination geometry, lattice compatibility, and reaction feasibility for inorganic targets and stability, stereochemistry, and reactivity for organic targets.

In one embodiment, the recursive planning pipeline combines discriminative processing by the rule-based model with generative prediction by a large language model to achieve controlled generation of transformation pathways that are both novel and valid. In one embodiment, the apparatus is configured to execute a race condition or decision mechanism in which both the rule-based model and the generative model independently propose candidate transformations, and a selection module chooses an optimal pathway based on confidence scoring.

In one embodiment, a method is configured for executing a recursive planning pipeline that integrates at least one generative model and at least one rule-based model to generate candidate transformation pathways for a target structure, applying one or more verification modules to evaluate validity, stability, and coherence of intermediate outputs, selectively regenerating portions of the candidate transformation pathways from a user-specified stage while preserving validated portions, and incorporating user feedback to refine subsequent pathway generation and model operation.

In one embodiment, a computer program product is embodied on a non-transitory computer-readable medium comprising instructions that, when executed by a processor, cause the processor to perform operations comprising executing a recursive planning pipeline that integrates at least one generative model and at least one rule-based model to generate candidate transformation pathways for a target structure, applying one or more verification modules to evaluate validity, stability, and coherence of intermediate outputs, selectively regenerating portions of the candidate transformation pathways from a user-specified stage while preserving validated portions, and incorporating user feedback to refine subsequent pathway generation and model operation.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,”and “the”also refer to “one or more”unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present invention may be embodied in other specific forms without departing from its spirit or essential characteristics. The described embodiments are to be considered in all respects only as illustrative and not restrictive. The scope of the inventio is, therefore, indicated by the appended claims rather than by the foregoing description. All changes which come within the meaning and range of equivalency of the claims are to be embraced within their scope.

What is claimed is:

1. An apparatus, comprising:
at least one memory; and
at least one processor coupled with the at least one memory and configured to cause the apparatus to:
execute a recursive planning pipeline that integrates at least one generative model and at least one rule-based model to generate candidate transformation pathways for a target structure;
apply one or more verification modules to evaluate validity, stability, and coherence of intermediate outputs;
selectively regenerate portions of the candidate transformation pathways from a user-specified stage while preserving validated portions; and
incorporate user feedback to refine subsequent pathway generation and model operation.

2. The apparatus of claim 1, wherein the candidate transformation pathways comprise alternative multi-step sequences representing transformations between a target structure and one or more precursor structures, wherein each candidate transformation pathway is characterized by at least one transformation rule, reaction template, or model-generated operation connecting intermediate states within the sequence.

3. The apparatus of claim 1, wherein the intermediate outputs comprise representations of partial transformations or precursor structures generated at successive stages of the recursive planning pipeline, wherein the intermediate outputs are evaluated for structural validity, energetic stability, or logical consistency prior to continuation of the pipeline.

4. The apparatus of claim 1, wherein the one or more verification modules comprise a validity checker configured to evaluate chemical or structural correctness of the intermediate outputs, a stability checker configured to assess energetic or functional stability, and a coherence checker configured to detect or mitigate hallucinated or implausible transformations produced by the generative model.

5. The apparatus of claim 1, wherein the processor is configured to cause the apparatus to receive user feedback through at least one interface to modify or constrain model operation, wherein the user feedback comprises corrections to structural representations, exclusion of specified transformation types, or directional guidance for alternative pathway exploration.

6. The apparatus of claim 1, wherein the processor is configured to cause the apparatus to regenerate a portion of the candidate transformation pathways from a user-selected stage within the recursive planning pipeline while retaining preceding validated pathway segments, thereby enabling targeted refinement without full recomputation of the candidate transformation pathways.

7. The apparatus of claim 1, wherein the processor is configured to cause the apparatus to record user feedback and verification outcomes to update model parameters or decision policies, thereby enabling adaptive improvement of subsequent pathway generation operations.

8. The apparatus of claim 1, wherein the recursive planning pipeline is executed across a distributed computing architecture comprising a head node configured to manage task allocation and a plurality of worker nodes configured to concurrently process candidate transformation pathways for different target structures or recursive stages.

9. The apparatus of claim 8, wherein the head node prioritizes pathway execution based on one or more metrics including scalability index, confidence score, or number of transformation steps.

10. The apparatus of claim 1, further comprising a reinforcement learning agent configured to optimize pathway generation decisions based on accumulated user interactions, pathway validation results, and system performance metrics.

11. The apparatus of claim 10, wherein the reinforcement learning agent comprises a policy network configured to predict optimal actions for pathway expansion and a value network configured to estimate expected rewards associated with candidate pathways.

12. The apparatus of claim 10, wherein the reinforcement learning agent is trained using imitation learning from expert user interactions and reinforcement learning through autonomous exploration of pathway generation outcomes.

13. The apparatus of claim 1, further comprising a metadata generation subsystem configured to augment each transformation pathway with information including reagent identification, reaction condition determination, and literature evidence correlation.

14. The apparatus of claim 13, wherein the metadata generation subsystem retrieves precedent reactions, patent data, or publication references and associates corresponding citations with nodes of the transformation pathway.

15. The apparatus of claim 14, wherein the recursive planning pipeline is configured to generate transformation pathways for both organic and inorganic molecular systems, including natural products, semiconductor film precursors, and metal-organic frameworks.

16. The apparatus of claim 15, wherein the one or more verification modules and the metadata generation subsystem are each configured to apply domain-specific validation and annotation protocols for organic and inorganic molecular systems, including validation of coordination geometry, lattice compatibility, and reaction feasibility for inorganic targets and stability, stereochemistry, and reactivity for organic targets.

17. The apparatus of claim 1, wherein the recursive planning pipeline combines discriminative processing by the rule-based model with generative prediction by a large language model to achieve controlled generation of transformation pathways that are both novel and valid.

18. The apparatus of claim 1, wherein the processor is configured to cause the apparatus to execute a race condition or decision mechanism in which both the rule-based model and the generative model independently propose candidate transformations, and a selection module chooses an optimal pathway based on confidence scoring.

19. A method, comprising:
executing a recursive planning pipeline that integrates at least one generative model and at least one rule-based model to generate candidate transformation pathways for a target structure;
applying one or more verification modules to evaluate validity, stability, and coherence of intermediate outputs;
selectively regenerating portions of the candidate transformation pathways from a user-specified stage while preserving validated portions; and
incorporating user feedback to refine subsequent pathway generation and model operation.

20. A computer program product comprising a non-transitory computer-readable medium storing instructions that, when executed by one or more processors, cause the one or more processors to:
execute a recursive planning pipeline that integrates at least one generative model and at least one rule-based model to generate candidate transformation pathways for a target structure;
apply one or more verification modules to evaluate validity, stability, and coherence of intermediate outputs;
selectively regenerate portions of the candidate transformation pathways from a user-specified stage while preserving validated portions; and
incorporate user feedback to refine subsequent pathway generation and model operation.
